(19) United States
(12) Patent Application Publication
(10) Pub. No.: US 2026/0075106 A1
(43) Pub. Date: Mar. 12, 2026

(54) Network Control System and Program

(71) Applicant: FurtherSystem Co., Ltd., Tokyo (JP)

(72) Inventor: Ryuichi SAEKI, Tokyo (JP)

(21) Appl. No.: 19/390,436

(22) Filed: Nov. 14, 2025

Related U.S. Application Data
(63) Continuation of application No. PCT/JP2023/027036, filed on Jul. 24, 2023.

(30) Foreign Application Priority Data
Jun. 29, 2023 (JP) 2023-107578

(51) Int. Cl. H04L 67/1095; H04L 47/11; H04L 69/16

(52) U.S. Cl. CPC H04L 67/1095; H04L 47/11; H04L 69/16

(57) ABSTRACT

A network control system includes a plurality of client terminals, a real-time network infrastructure, a non-real-time network infrastructure, and a communication controlling device. When the communication controlling device receives information on a new client as an initial synchronization request from a new client terminal in an initial synchronization step at a time of switching modes when the new client terminal connects to the real-time network infrastructure, the latest information on plurality of clients connecting to the real-time network infrastructure is transmitted to the new client terminal via the real-time network infrastructure.

### CROSS-REFERENCE TO RELATED APPLICATIONS

This application is a continuation application of International Patent Application No. PCT/JP2023/027036 filed on Jul. 24, 2023, which claims priority to Japanese Patent Application No. 2023-107578 filed on Jun. 29, 2023, the entire contents of which are incorporated by reference.

### TECHNICAL FIELD

The present invention relates to a network control system and program.

### BACKGROUND ART

In recent years, with remarkable advances in network communications, the network communications are expected to support a wide variety of applications and uses in many fields.

In the following, “network communications” refers to all communication technologies for an exchange of data via the Internet.

In the network communications, a multicast is a technology that enables a batch transmission of data.

This multicast enables a batch broadcast transmission of data to a large number of clients at a single transmission processing cost.

However, although the multicast is currently available in local area networks, it is difficult to select and use the multicast as a general technology in communications via the Internet because it requires the use of a multicast-capable Internet Service Provider (ISP) and multicast-capable routers and other equipment. Therefore, although it exists as a standard, it is difficult to select and use it as a general technology.

Therefore, an alternative network technology to this is currently used for network caching, called Content Delivery Network (CDN).

There are two types of network communication: unicast communication for one-to-one communication, and multicast and broadcast communication for one-to-many communication.

However, as mentioned above, the use of the multicast communication via the Internet is not realistic and the broadcast communication is also the technology for communication within the same local area network that does not involve the Internet.

In a network service that provide an information processing via the Internet, a system consists of a client, which is a communication device on a user side of the network service, and a server, which is a provider of the network service.

In order to distinguish it from a real-time network communication described further below, it is hereinafter described as a “general network communication” (non-real-time network communication). For example, HTTP (Hypertext Transfer Protocol) communication can be the example of the “general network communication” (non-real-time network communication).

HTTP communication here refers to HTTP/1.0, HTTP/1.1, HTTP/2, HTTP/3 and their data exchange procedural procedures, related protocols and derived protocols.

In the general network communication, a data compression to reduce a communication data size and a data accumulation to reduce a number of communications by buffering a certain amount of transmitted data before transmission are often used, mainly to reduce frequency of communications and to achieve greater efficiency. Using such techniques increases the efficiency of the communication data size per communication and reduces communication costs.

Specifically, communication efficiency algorithms such as a Nagle algorithm are mainly used.

In addition, both the data compression and the data accumulation described above are performed in “communication margins”, where no communication takes place, caused by reducing the frequency of communication.

However, on the other hand, if this efficiency-enhancing processing is carried out in the time that should be used for an actual processing of data communications, due to a decrease in the margins as the frequency of communication increases, this can conversely lead to delays.

Therefore, in the general network communication, it is recommended to minimize the frequency of communication.

In addition, the general network communication is characterized by its strength in one-to-one individual communication rather than one-to-many batch distribution.

A stream network communication refers to the Real Time Streaming Protocol (RTSP), Real Time Messaging Protocol (RTMP) and other communication methods used for video and audio streaming.

The stream network communication distributes continuous data in batches to many users at high capacity and high frequency.

In order to withstand batch distribution for large-scale viewing, the system allows for variations in delay for each viewer. For example, in live streaming broadcast, when an event is delivered in video, the event is almost never delivered to all viewers at exactly the same time.

Since the stream network communication is inherently designed to tolerate latency, it is well-suited for enhancing communication efficiency through data accumulation techniques such as the data compression and network caching technologies like CDN.

The real-time network communication refers to a network communication in which very high frequency and large amounts of data are exchanged with participants and each other.

It is often used in videoconferencing systems that allow the users to talk to each other, or in VR or game systems that allow the users to share a space and communicate with each other in a highly responsive manner.

Since the real-time network communication requires highly responsive communication, it is characterized by the fact that delays are not tolerated (see, for example, Patent Literature 1).

For example, TCP, UDP, TLS, DTLS, QUIC and their data exchange procedures, related protocols, and derived protocols are used.

In order to enhance immediacy, low-layer protocols with relatively little processing tend to be adopted.

The general network communications can make extensive use of efficiency-enhancing processing by the data compression and the data accumulation instead of reducing the frequency of communications.

Thus, the Nagle algorithm is a transmission technique that improves the efficiency of a data transmission by packing all the data into a data area that can be loaded into a packet and transmitting the packet.

In today's “general network communications,” for example, it has become common to use the Nagle algorithm compression and accumulation techniques together, as illustrated in FIG. 10.

In other words, considering a transmission cost incurred for an act of transmitting one packet, it is better to transmit data packed as much as possible, since it saves the transmission cost per amount of data transmitted, resulting in an increase in the total net amount of data that can be transmitted.

On the other hand, due to the characteristics of the Nagle algorithm illustrated in FIG. 11, the use of the Nagle algorithm sacrifices immediacy and allows delays in exchange for increased efficiency in assured reachability per communication and communication data size.

In contrast, the real-time network communication is characterized by very high communication frequency and very small communication margins.

Therefore, the batch transmission by the data accumulation and compression techniques can actually cause delays, making them difficult to use, so the Nagle algorithm is often “disabled” in the real-time network communications.

When transmitting the same data in the same broadcast transmission, it is less likely to cause delays if the batch transmission is used.

FIG. 12 illustrates an overview of a batch network distribution in the real-time network. As illustrated in the figure, when client terminal A transmits data (1) in a real-time network service, for example, the data sent by client terminal A is distributed (2) to all client terminals A through N.

In other words, data can be delivered to many clients more quickly since it is batch distributed to all clients without any calculations such as identifying the destination.

Therefore, this is an efficient method for cases where a position and status of the client is to be synchronized with other clients in real time as needed.

Moreover, all clients are able to exchange information on their latest status with each other and maintain synchronization at all times through this mechanism.

FIG. 13 illustrates an overview of individual network distribution in the real-time network. As illustrated in the figure, when the client transmits data (1) in the real-time network service, the data is distributed (2) to specific clients.

In other words, data that is to be sent only to a specific client uses an individual network communication, not a batch network communication.

Unlike the state synchronization of the batch network communication, the purpose of individual network distribution is used often for processing the synchronized actions between specific clients.

For the transmitting client, a complex destination design for not only one but also two or three clients should be avoided as much as possible, since it leads to a decrease in overall transmission efficiency.

Even in the above cases, “batch network communication” is often used to implement the entire series of operations.

In individual network distribution methods that transmit different data to each user, determining the destination during transmission requires computational processing. This can easily cause delays, particularly in the real-time network communication, making such methods impractical for frequent use.

As explained in detail using FIG. 14, in the real-time network communication, there is an upper limit to the number of events that can be issued per unit of time for communication processing.

Both the individual network communication and the batch network communication consume this precious number of events.

Therefore, using “individual network communication” at a high frequency leads to a reduction in the amount of “batch network communication” that can be sent.

In addition, complex destination design also causes delays due to computational processing, leading to a decrease in overall transmission efficiency.

For these reasons, the use of the individual network communications has been avoided in favor of the batch network communications as much as possible.

For these reasons, in principle, data is often in the form of a broadcast distribution, which is sent to all participants in the real-time network communications.

For example, network devices such as a switching hub are based on the same concept, and in order to speed up the network communications, in principle, all communications are performed in the form of batch distribution.

Specifically, in the case of the switching hub, the machine side that receives data from the switching hub is designed to discard data not addressed to itself.

Therefore, the batch transmission is one of the mechanisms that enable the real-time network communication to guarantee immediate response.

In the stream network communication, all that is required is that video and audio streaming is performed normally, so there are no problems with continuous data reception, and delays in the start of transmission itself, as mentioned above, are not a problem.

Therefore, in the stream network communication, it is easy to improve efficiency by the batch transmission through the data compression and the data accumulation.

On the other hand, in the real-time network communication, if there is a delay in the start time of data reception for each user, it will be difficult to carry out normal exchanges when communication that requires immediate response occurs.

Therefore, in the real-time network communication, no delay in continuous data reception, nor any delay in the start time of the data transmission itself is allowed.

While the real-time network communication is the technology with high expectations, there are many cases where it is used in over-promotion as the “real-time network communication” for the sake of each company's sales strategy, even if the technology is clearly less immediately applicable. In addition to this, the exact interpretation may vary widely among organizations and individuals, making it difficult to use the terminology in patent documents, where accuracy is required. Therefore, for convenience of explanation, the term “real-time network communication” hereafter will be used to refer to the network communication that satisfies the following condition:
Network communication in which the Nagle algorithm or equivalent technology is “disabled”.

As long as this is satisfied, the term “real-time network communication” will be used hereafter, regardless of protocol or method.

In contrast to “real-time network communication”, for the sake of explanation, the term “non-real-time network communication” will be used hereafter to refer to the network communications that satisfy the following condition:
Network communications in which the Nagle algorithm or equivalent technology is “enabled”.

As long as this is satisfied, the term “non-real-time network communication” will be used hereafter regardless of protocol or method.

### RELATED ART LITERATURE

### Patent Literature

Japanese Unexamined Patent Application Publication No. 2005-169138

### SUMMARY OF INVENTION

### Technical Problem

By the way, in the real-time network communication, regardless of the method, procedure similar to a mode switching is performed at the beginning in order to enable highly responsive communication among participants.

Although it depends on a product, the mode switching is often performed in the following manner:
Enter or leave a virtual room dedicated for the real-time network communication.
Subscribe to or cancel a dedicated channel for the real-time network communication.

After the mode switching, the participants who have entered the same room or subscribed to the same channel will be able to perform mutual, immediate network communication and the real-time network communication with each other.

The expression is not limited to this, as long as the same procedures are used for the real-time network communication.

In the following, the above process is described as the “mode switching”.

In the real-time network communication, when a new client switches modes for the real-time network communication, it acquires latest information of clients already participating in the real-time network communication. This initial synchronization process is hereinafter referred to as “initial synchronization”.

In general, the initial synchronization is performed as follows:
The initial synchronization may be performed using the batch network distribution of a real-time network infrastructure, in which case unnecessary information that already exists for other clients is distributed, consuming communication bandwidth that was originally available for communication and degrading a distribution performance of the entire real-time network infrastructure.
In some cases, the initial synchronization is performed using the individual network distribution of the real-time network infrastructure, which consumes the number of times the real-time network infrastructure can issue events, thus degrading the distribution performance of the entire real-time network infrastructure.
In order to prevent a degradation of a delivery performance of the real-time network infrastructure, the initial synchronization may not be performed, and a minimum necessary amount of data may be obtained only after it is needed, which may cause visual discomfort, such as a sudden appearance of other clients on a display.

In a multi-person real-time network communication, the real-time network communication is performed with 100 to 10,000 participants or more in a multi-person simultaneously connected state.

In ordinary real-time network communication, the number of participants is often assumed to be from 5 to 20.

This makes it even more difficult to introduce the real-time network communications, which originally had high technical hurdles to overcome.

The multi-person real-time network communication has a load called an initial synchronization network load.

As illustrated in FIG. 15, the initial synchronization network load refers to a high load that is temporarily generated in the process of collecting all the information of participants in a room or channel when a new participant joins the real-time network service to which many client terminals are already connected.

The abovementioned load is hereinafter described as “initial synchronization load”.

A new client terminal X does not know a latest status of the real-time network service.

Therefore, the new client terminal X makes a request (1) to all client terminals to obtain the latest information in order to grasp the latest status.

The request to obtain the latest information is distributed (2) to all client terminals using the batch network communication of the real-time network service.

As illustrated in FIG. 16, in response to the request for the latest information received from the new client terminal X, all participating client terminals respond (1) with their respective latest information.

The latest information is then distributed (2) to all clients via the batch network communication.

In other words, in the initial synchronization, the initial synchronization information of all clients is distributed to all client terminals, even though the data size tends to be large.

On the other hand, only the new client terminal X needs the initial synchronization data, and the other client terminals already have the synchronization information, so unnecessary information is sent to them.

When the initial synchronization load occurs, especially in the multi-person real-time network communication, the likelihood of hitting network capacity limits increases.

When the network capacity limits are reached, overflowing data may be treated as lost data outright, or retry processing may attempt to reacquire it. However, an inability to perform this communication frequently causes the following issues to occur:
Delay of the entire real-time network communication due to communication failures
Frequent disconnections due to communication failures

A particular problem with the initial synchronization network load is that, although there is a considerable margin in terms of an estimated data size for an actual number of people who can connect, the initial synchronization network load often causes connection failures for new real-time network participants and forced disconnections for existing real-time network participants when the number of people is far below the upper limit.

The purpose of the present invention, therefore, is to provide a network control system and program that avoids the initial synchronization load and utilizes the pre-given network transfer capacity limit without waste.

### Solution to Problem

Form 1; One or more embodiments of the invention proposes a network control system comprising:
a plurality of client terminals;
a real-time network infrastructure connecting the plurality of client terminals;
a non-real-time network infrastructure connecting the plurality of client terminals; and
a communication controlling device that controls data communications in the real-time network infrastructure and the non-real-time network infrastructure,
wherein, in an initial synchronization step at a time of switching modes when a new client terminal connects to the real-time network infrastructure, if the communication controlling device receives information on a new client as an initial synchronization request from the new client terminal, the communication controlling device transmits latest information on plurality of clients connected to the real-time network infrastructure to the new client terminal via the non-real-time network infrastructure.

Form 2; One or more embodiments of the invention proposes the network control system,
wherein the communication controlling device comprises:
a detector that detects a congestion state of the real-time network infrastructure when information on the new client is received from the new client terminal as the initial synchronization request during the initial synchronization step at the time of switching modes when the new client terminal connects to the real-time network infrastructure; and
a determiner that determines whether the congestion state is above a standard congestion level,
wherein, the communication controlling device transmits the latest information of the plurality of clients connected to the real-time network infrastructure to the new client terminal via the non-real-time network infrastructure if the congestion state is determined by the determiner to be above the standard congestion level.

Form 3; One or more embodiments of the invention proposes the network control system,
wherein the communication controlling device comprises a memory that stores the latest information on the plurality of clients connected to the real-time network infrastructure.

Form 4; One or more embodiments of the invention proposes the network control system,
wherein the communication controlling device comprises a compressor that compresses the latest information on the plurality of clients connected to the real-time network infrastructure stored in the memory.

Form 5; One or more embodiments of the invention proposes the network control system,
wherein, when the communication controlling device receives information on the new client as the initial synchronization request from the new client terminal, the communication controlling device uses the Nagle algorithm to transmit the latest information on the plurality of clients connected to the real-time network infrastructure to the new client terminal via the non-real-time network infrastructure.

Form 6; One or more embodiments of the invention proposes a program for having a computer execute a network control method in a network control system comprising:
a plurality of client terminals;
a real-time network infrastructure connecting the plurality of client terminals;
a non-real-time network infrastructure connecting the plurality of client terminals; and
a communication controlling device controlling data communications in the real-time network infrastructure and the non-real-time network infrastructure, and comprising the steps of:
a client information receiving step in which the communication controlling device receives information on a new client as an initial synchronization request from a new client terminal in an initial synchronization step during switching modes where the new client terminal connects to the real-time network infrastructure; and
an information transmission step in which the communication controlling device transmits latest information on the plurality of clients connected to the real-time network infrastructure to the new client terminal via the non-real-time network infrastructure.

Form 7; One or more embodiments of the invention proposes the program comprising:
a congestion state detection step in which the communication controlling device detects a congestion state of the real-time network infrastructure; and
a determination step in which the communication controlling device determines whether the congestion state is above a standard congestion level,
wherein, when it is determined in the determination step that the congestion state is above the standard congestion level, the communication controlling device transmits the latest information on the plurality of clients connected to the real-time network infrastructure via the non-real-time network infrastructure to the new client terminal, in the information transmission step.

Form 8; One or more embodiments of the invention proposes the program,
wherein the communication controlling device comprises an information storage step for storing the latest information on the plurality of clients connected to the real-time network infrastructure prior to the information transmission step.

Form 9; One or more embodiments of the invention proposes the program,
wherein the communication controlling device comprises an information compression step to compress stored latest information on the plurality of clients connecting to the real-time network infrastructure.

Form 10; One or more embodiments of the invention proposes the program,
wherein the communication controlling device uses a Nagle algorithm in the information transmission step to transmit the latest information on the plurality of clients connected to the real-time network infrastructure to the new client terminal via the non-real-time network infrastructure, and the new client terminal transmits the new client information to the communication controlling device as the initial synchronization request using the Nagle algorithm.

One or more embodiments of the invention have the effect of avoiding the initial synchronization load and utilizing the pre-given network transfer capacity limit without waste.

### BRIEF DESCRIPTION OF DRAWINGS

FIG. 1 illustrates a configuration of a network control system according to a first embodiment of the present invention.

FIG. 2 illustrates the configuration of a communication controlling device according to the first embodiment of the present invention.

FIG. 3 illustrates a processing flow of the network control system according to the first embodiment of the present invention.

FIG. 4 illustrates a configuration of the network control system according to a second embodiment of the present invention.

FIG. 5 illustrates the configuration of a communication controlling device according to the second embodiment of the present invention.

FIG. 6 illustrates a processing flow of the network control system according to the second embodiment of the present invention.

FIG. 7 illustrates a configuration of a network control system according to a third embodiment of the present invention.

FIG. 8 illustrates the configuration of a communication controlling device according to the third embodiment of the present invention.

FIG. 9 illustrates a processing flow of the network control system according to the third embodiment of the present invention.

FIG. 10 illustrates benefits of a Nagle algorithm.

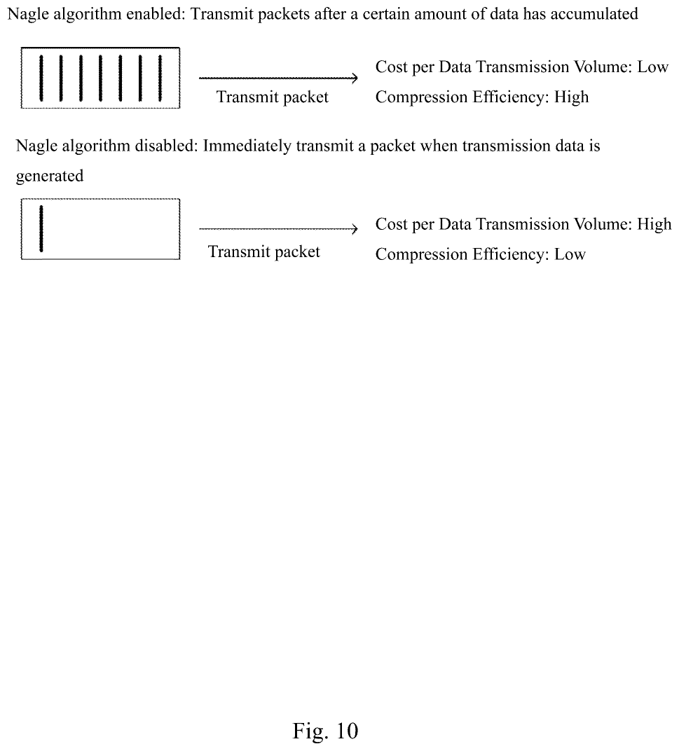

FIG. 11 illustrates a relationship between the Nagle algorithm and a real-time network.

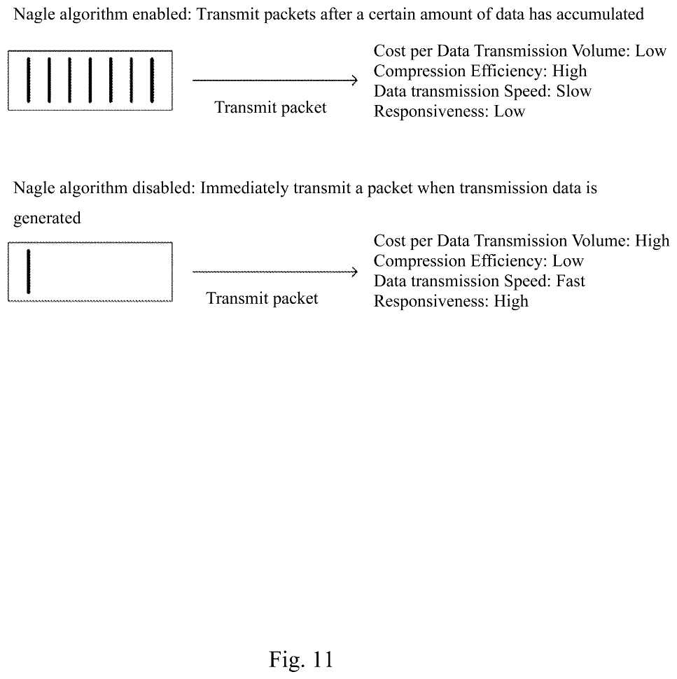

FIG. 12 illustrates an overview of a batch network distribution in the real-time network.

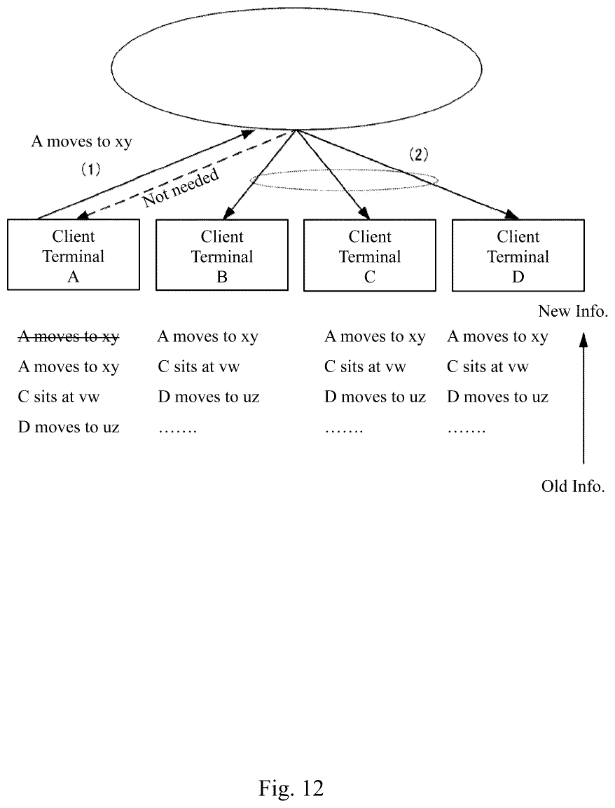

FIG. 13 illustrates the overview of an individual network distribution in the real-time network.

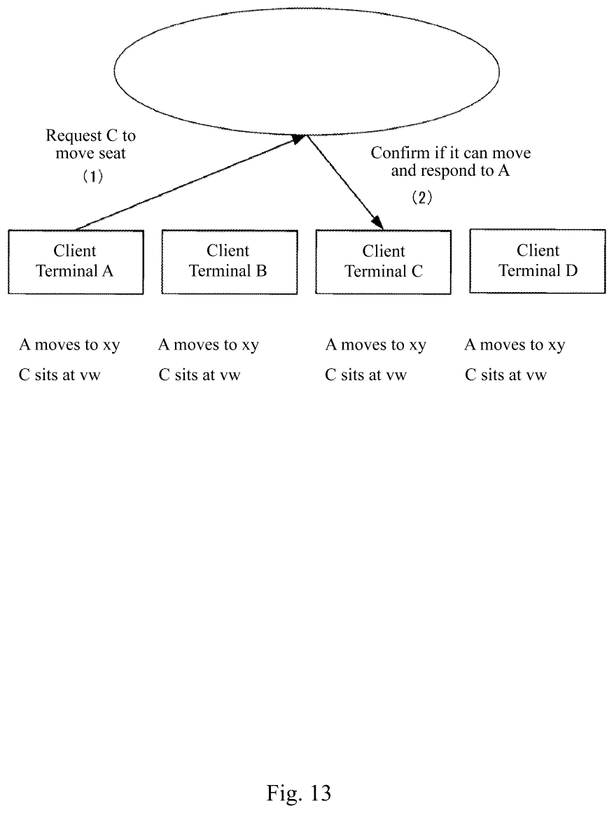

FIG. 14 illustrates why the individual network distribution cannot be used extensively in the real-time network.

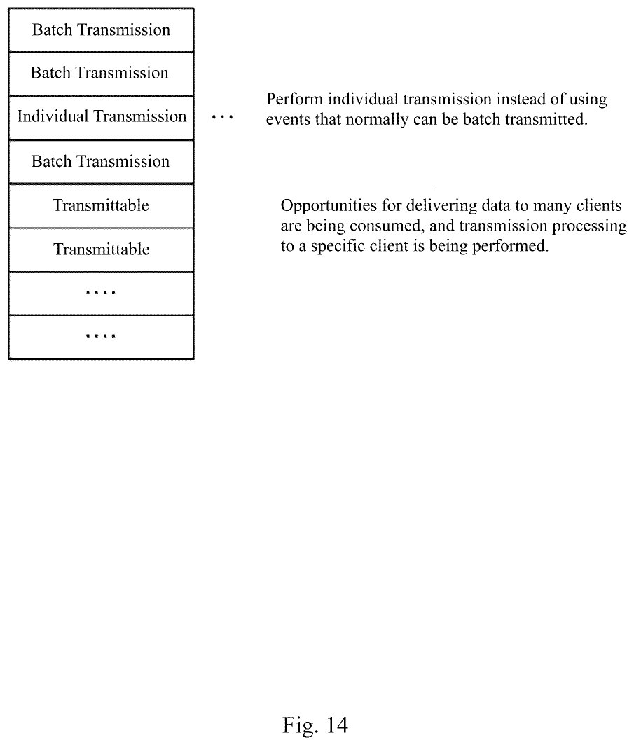

FIG. 15 illustrates an initial synchronization load that occurs in the real-time network communication.

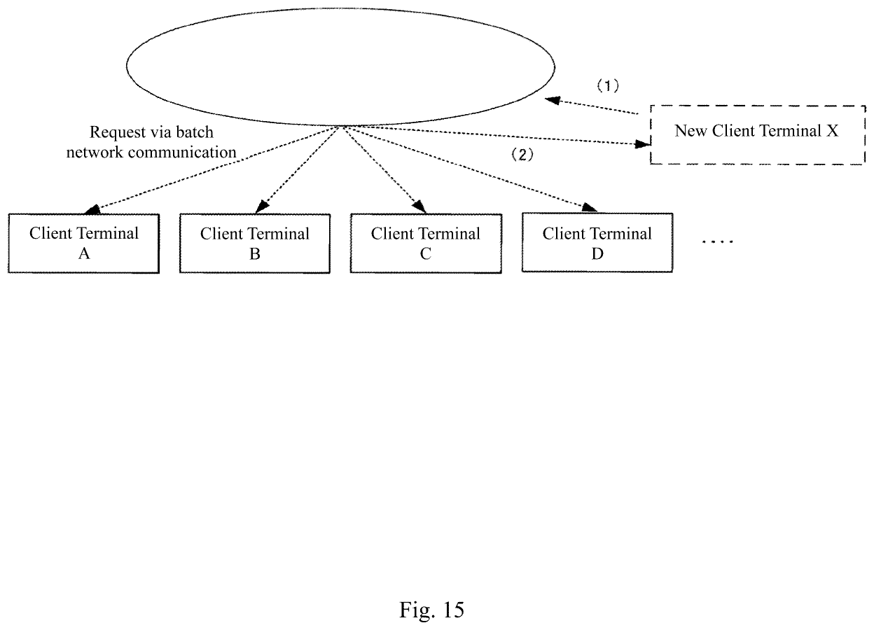

FIG. 16 illustrates the initial synchronization load that occurs in the real-time network communication.

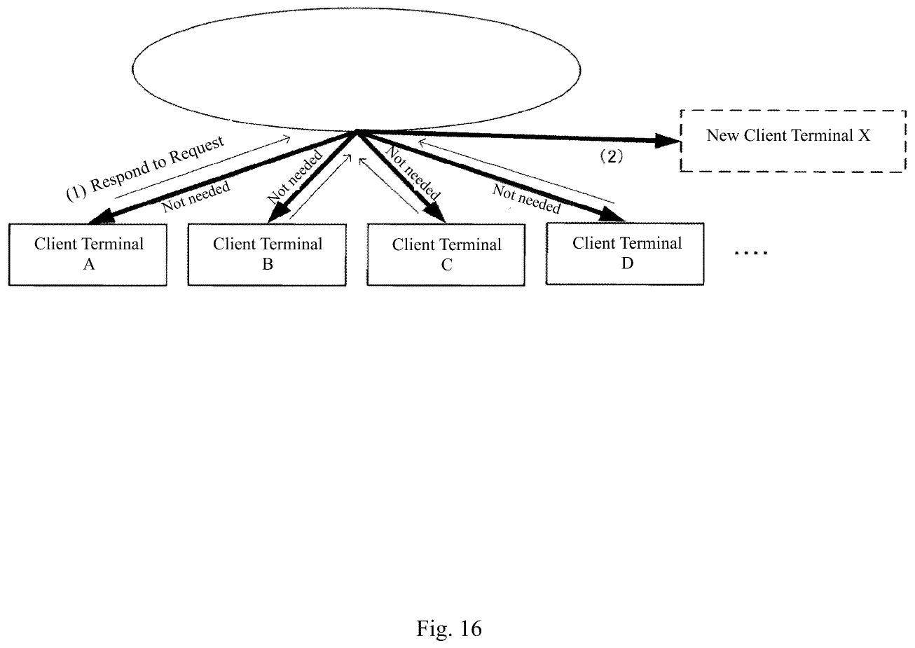

### DESCRIPTION OF EMBODIMENT

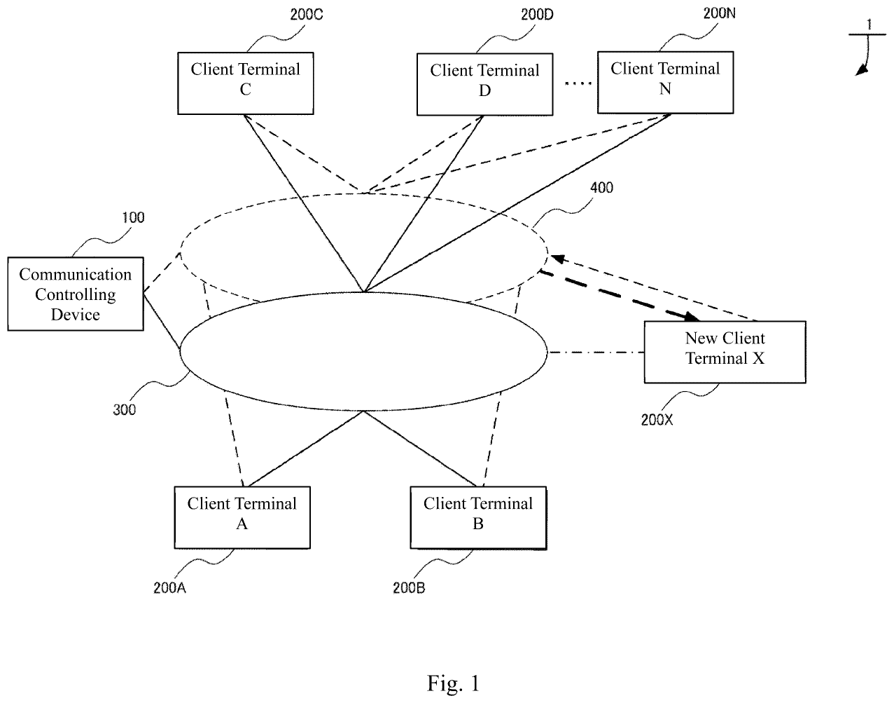

FIG. 1 to FIG. 9 are used to describe a network control system according to the present embodiment.

### First Embodiment

FIG. 1 to FIG. 3 are used to describe a network control system 1.

### Network Control System 1

As illustrated in FIG. 1, the network control system 1 in the present embodiment comprises a communication controlling device 100, client terminals 200A-200N, a new client terminal 200X, a real-time network infrastructure 300, and a non-real-time network infrastructure 400.

The communication controlling device 100, for example, is arranged in the cloud and controls communication between the client terminals 200A-200N and the new client terminal 200X via the real-time network infrastructure 300 or the non-real-time network infrastructure 400, or between the client terminals 200A-200N and the new client terminal 200X.

The communication controlling device 100, for example, during an initial synchronization step when the new client terminal 200X switches modes to connect to the real-time network infrastructure 300, upon receiving new client information from the new client terminal 200X as an initial synchronization request, transmits latest information on plurality of clients connected to the real-time network infrastructure 300 via the non-real-time network infrastructure 400 to the new client terminal 200X.

Details of a configuration of the communication controlling device 100 are described further below.

In the following, the communication controlling device 100 may be a server or a part of the client terminals 200A-200N may play this role.

In this and the following embodiments, the communication controlling device 100 is described by way of example as described above, performing communication control in the non-real-time network infrastructure 400 and the real-time network infrastructure 300.

However, in the present and the following embodiments, the communication controlling device 100 may perform the same functions as described above by performing inter-memory communication in the non-real-time network infrastructure 400 and real-time network infrastructure 300 connected to each other.

The client terminals 200A-200N are terminals already owned by clients connected to the real-time network infrastructure 300, such as personal computers, tablets, or smartphones, VR, AR or MR devices.

The new client terminal 200X is the terminal owned by the client who newly connects to the real-time network infrastructure 300 to which the client terminals 200A-200N are already connected, such as the personal computers, the tablets, the smartphones, VR, AR, or MR devices.

The new client terminal 200X, for example, transmits its own information as the initial synchronization request to the communication controlling device 100, and receives the latest information of plurality of clients connected to the real-time network infrastructure 300 from the communication controlling device 100 via the non-real-time network infrastructure 400.

The real-time network infrastructure 300 is a network where very high frequency and large amounts of data are exchanged between clients.

The real-time network infrastructure 300 is connected to the non-real-time network infrastructure 400, described further below, via the communication controlling device 100.

Hereinafter, the real-time network infrastructure 300 refers to the network infrastructure that does not tolerate delays, can achieve high responsiveness, and has “disabled” a Nagle algorithm or an equivalent technology.

The non-real-time network infrastructure 400 is described as the network infrastructure “enabled” with the Nagle algorithm or the equivalent technology, or the non-real-time network infrastructure, in order to clearly distinguish from the real-time network infrastructure 300.

The non-real-time network infrastructure 400 is connected to the real-time network infrastructure 300 via the communication controlling device 100.

### Configuration of Communication Controlling Device 100

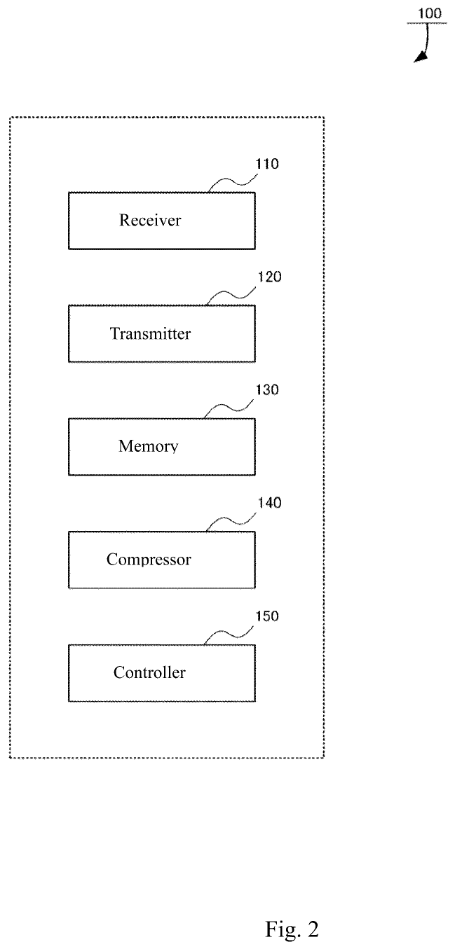

As illustrated in FIG. 2, the communication controlling device 100 comprises a receiver 110, a transmitter 120, a memory 130, a compressor 140, and a controller 150.

The receiver 110 receives information on new clients, for example, as the initial synchronization request from the new client terminal 200X.

The receiver 110 receives, for example, the latest information of plurality of clients from client terminals 200A-200N connected to the real-time network infrastructure 300 via the real-time network infrastructure 300.

The information on the new clients received by the receiver 110 and the latest information on the plurality of clients from the client terminals 200A-200N connected to the real-time network infrastructure 300 are output to the controller 150, described further below, and the latest information of plurality of clients from the client terminals 200A-200N that connect to the real-time network infrastructure 300 is stored by the controller 150 in the memory 130 described further below.

The transmitter 120 transmits, for example, the latest information of the plurality of clients connected to the real-time network infrastructure 300 to the new client terminal 200X via the non-real-time network infrastructure 400 based on a control signal from the controller 150 described further below.

The memory 130 is a rewritable volatile memory such as SRAM (Static Random Access Memory) or DRAM (Dynamic Random Access Memory).

The memory 130, for example, has defined memory areas corresponding to the plurality of client terminals 200A-200N and the memory areas for storing information on the new clients, and the latest information of the plurality of clients from the client terminals 200A-200N connected to the real-time network infrastructure 300 received by the receiver 110 is overwritten and updated with the latest information for each client each time it is received. Alternatively, each time the data is received, it is accumulated in the form of an additional update of all the data received for each client.

The compressor 140 compresses the latest information of the plurality of clients stored in the memory 130 into a single data group.

The data group compressed by the compressor 140 is output to the controller 150, described further below, and is transmitted from the transmitter 120 via the non-real-time network infrastructure 400 to the new client terminal 200X with the latest information of the plurality of clients connected to the real-time network infrastructure 300.

The controller 150 controls an operation of an entire network control system 1 according to a control program stored in ROM (Read Only Memory) or other memory.

Specifically, the controller 150 performs a reception control of the receiver 110, a transmission control of the transmitter 120, a writing and reading control of data to the memory 130, and a compression control of the compressor 140.

For example, when the receiver 110 receives information on the new client as the initial synchronization request from the new client terminal, the controller 150 controls the transmitter 120 to use the Nagle algorithm to transmit the latest information of the plurality of clients connected to the real-time network infrastructure 300 to the new client terminal 200X via the non-real-time network infrastructure 400.

### Processing of Communication Controlling Device 100

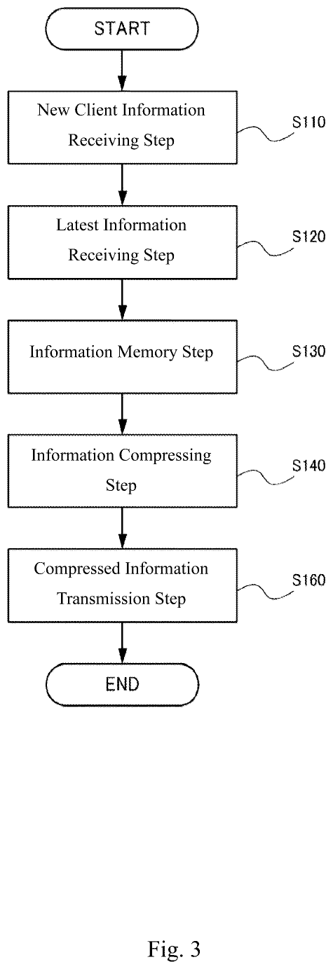

FIG. 3 describes the processing of the network control system 1 according to the present embodiment.

The receiver 110 receives the new client information from the new client terminal 200X as the initial synchronization request (step S110).

The new client information (new client information) received by the receiver 110 is output to the controller 150.

The receiver 110 receives the latest information of the plurality of clients from the client terminals 200A-200N connected to the real-time network infrastructure via the real-time network infrastructure 300 (step S120).

The latest information of the plurality of clients from the client terminals 200A-200N connected to the real-time network infrastructure received by the receiver 110 is output to the controller 150.

The controller 150 performs a process of writing the latest information of the plurality of clients from the client terminals 200A-200N connected to the real-time network infrastructure received from the receiver 110 to the storage area corresponding to the plurality of client terminals 200A-200N in the memory 130, thereby updating the information in the storage area corresponding to the plurality of client terminals 200A-200N (step S130).

When the controller 150 receives information on the new client from the receiver 110, it reads the latest information on the plurality of clients in the storage area corresponding to the plurality of client terminals 200A-200N provided in the memory 130, and outputs to the compressor 140 a control signal for compressing and processing of the information.

The compressor 140 compresses the latest information of the input group and outputs to the controller 150 (step S140).

The controller 150 outputs the latest information of the group of compressed information received from the compressor 140 to the transmitter 120, and also transmits the control signal commanding the new client terminal 200X to transmit the latest information of the plurality of clients connected to the real-time network infrastructure 300 via the non-real-time network infrastructure 400. (Step S160).

At this time, the controller 150 may cause the transmitter 120 to transmit the information using the Nagle algorithm.

### Effect

As described above, the network control system 1 according to the present embodiment comprises the plurality of client terminals 200A-200N, the real-time network infrastructure 300 connecting the plurality of client terminals 200A-200N, the non-real-time network infrastructure 400 connecting the plurality of client terminals 200A-200N, and the communication controlling device 100 that controls data communications in the real-time network infrastructure 300 and the non-real-time network infrastructure 400. In the initial synchronization step at the time of switching modes of the new client terminal 200X connecting to the real-time network infrastructure 300, when the new client information is received from the new client terminal 200X as the initial synchronization request, the communication controlling device 100 transmits the latest information of the plurality of clients connected to the real-time network infrastructure 300 via the non-real-time network infrastructure 400 to the new client terminal 200X.

In other words, in the initial synchronization step when switching modes to connect the new client terminal 200X to the real-time network infrastructure 300, the communication control device 100 transmits the latest information of the plurality of clients connected to the real-time network infrastructure 300 to the new client terminal 200X via the non-real-time network infrastructure 400.

This effectively avoids an initial synchronization load and allows a pre-given network transfer capacity limit to be used without waste.

The communication controlling device 100 of the network control system 1 according to the present embodiment has the memory 130 that stores the latest information of the plurality of clients connected to the real-time network infrastructure 300, and the compressor 140 that compresses the latest information of the plurality of clients connected to the real-time network infrastructure 300 stored in the memory 130

In other words, the memory 130 stores the latest information of the plurality of clients connected to the real-time network infrastructure 300, and the compressor 140 compresses the latest information of the plurality of clients connected to the real-time network infrastructure 300 stored in the memory 130.

The transmitter 120 then transmits the compressed latest information of the plurality of clients connected to the real-time network infrastructure 300 to the new client terminal 200X via the non-real-time network infrastructure 400.

This effectively avoids the initial synchronization load and allows the pre-given network transfer capacity limit to be used without waste.

When the communication controlling device 100 of the network control system 1 according to the present embodiment receives information of the new client as the initial synchronization request from the new client terminal, the latest information on the plurality of clients connected to the real-time network infrastructure is transmitted via the non-real-time network infrastructure 400 to the new client terminal 200X using the Nagle algorithm.

This effectively avoids the initial synchronization load and allows the pre-given network transfer capacity limit to be used without waste.

### Second Embodiment

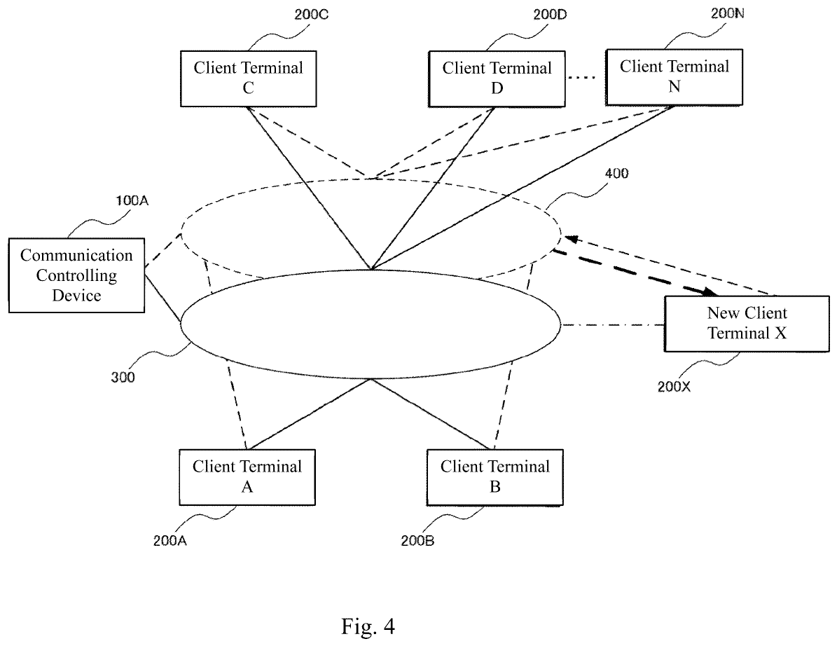

FIG. 4 to FIG. 6 are used to describe a network control system 1A according to a present embodiment.

### Network Control System 1A

As illustrated in FIG. 4, the network control system 1A according to the present embodiment comprises a communication controlling device 100A, client terminals 200A-200N, a new client terminal 200X, a real-time network infrastructure 300, and a non-real-time network infrastructure 400.

Detailed descriptions of components with the same symbols as in a first embodiment are omitted, as they have the same functions.

The communication controlling device 100A, for example, during an initial synchronization step when the new client terminal 200X switches modes to connect to the real-time network infrastructure 300, upon receiving new client information from the new client terminal 200X as an initial synchronization request, transmits latest information on plurality of clients connected to the real-time network infrastructure 300 via the non-real-time network infrastructure 400 to the new client terminal 200X.

Details of a configuration of the communication controlling device 100 are described further below.

### Configuration of Communication Controlling Device 100A

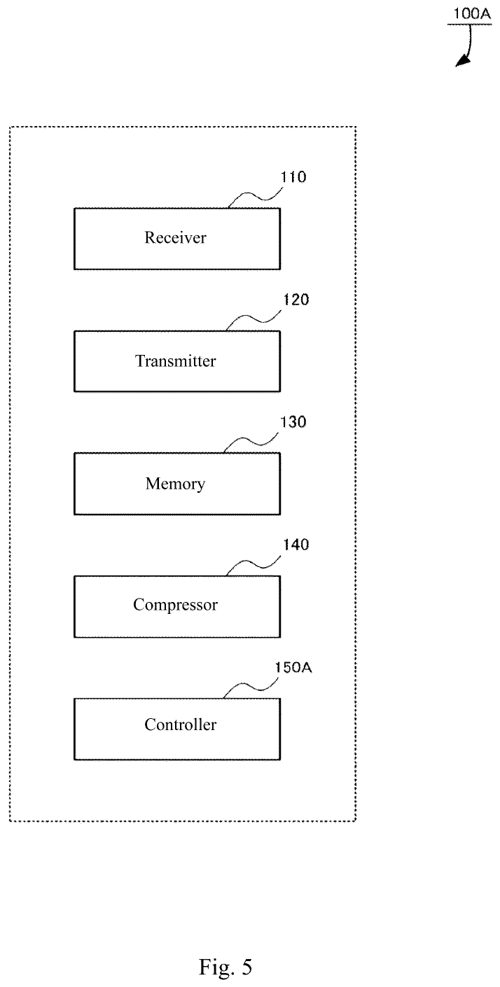

As illustrated in FIG. 5, the communication controlling device 100A comprises a receiver 110, a transmitter 120, a memory 130, a compressor 140, and a controller 150A.

Detailed descriptions of the components with the same symbols as in the first embodiment are omitted, as they have the same functions.

The controller 150A controls an operation of an entire network control system 1A according to a control program stored in ROM (Read Only Memory) or the like.

In the present embodiment, the controller 150A, for example, in the initial synchronization step at the time of switching modes when the new client terminal 200X connects to the real-time network infrastructure 300, when receiving information on a new client as the initial synchronization request from the new client terminal 200X, the latest information of the plurality of clients connected to the real-time network infrastructure 300 is transmitted to the new client terminal 200X via the non-real-time network infrastructure 400.

For example, when the receiver 110 receives the information on the new client as the initial synchronization request from the new client terminal 200X, the controller 150A controls the transmitter 120 to use the Nagle algorithm to transmit, via the non-real-time network infrastructure 400, the latest information of the plurality of clients connected to the real-time network infrastructure 300 to the new client terminal 200X.

### Processing of Communication Controlling Device 100A

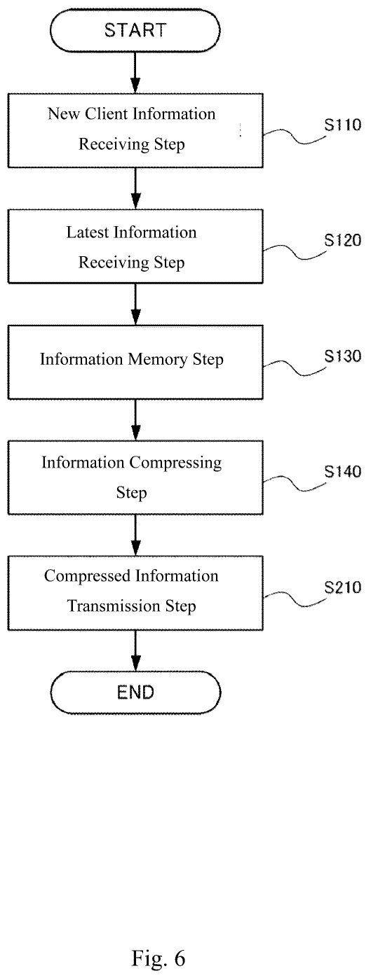

FIG. 6 is used to describe the processing of the network control system 1A according to the present embodiment.

The receiver 110 receives information on the new client from the new client terminal 200X as an initial synchronization request (step S110).

Information on the new client (new client information) received by the receiver 110 is output to the controller 150.

The receiver 110 receives the latest information of the plurality of clients from the client terminals 200A-200N connected to the real-time network infrastructure via the real-time network infrastructure 300 (step S120).

The latest information of the plurality of clients from the client terminals 200A-200N connected to the real-time network infrastructure received by the receiver 110 is output to the controller 150.

The controller 150A writes the latest information of the plurality of clients from the client terminals 200A-200N connected to the real-time network infrastructure received from the receiver 110 to a storage area corresponding to the plurality of client terminals 200A-200N in the memory 130. Thus, the information in the storage area corresponding to the plurality of client terminals 200A-200N is updated (step S130).

When the controller 150A receives information on the new client from the receiver 110, the controller 150A reads the latest information on the plurality of clients in the storage area corresponding to the plurality of client terminals 200A-200N in the memory 130, and outputs a control signal for compression and processing of this information to the compressor 140.

The compressor 140 compresses the latest information of the input group and outputs to the controller 150 (step S140).

The controller 150A outputs the latest information of a group of compressed information received from the compressor 140 to the transmitter 120, and also transmits the control signal commanding to transmit the latest information of the plurality of clients connected to the real-time network infrastructure 300 to the new client terminal 200X via the non-real-time network infrastructure 400 (step S210).

### Effect

As described above, the network control system 1A according to the present embodiment comprises the plurality of client terminals 200A-200N, the real-time network infrastructure 300 connecting the plurality of client terminals 200A-200N, the non-real-time network infrastructure 400 connecting the plurality of client terminals 200A-200N, and the communication controlling device 100A controlling the data communications of the real-time network infrastructure 300 and the non-real-time network infrastructure 400. When the communication controlling device 100A receives information on the new client as the initial synchronization request from the new client terminal 200X in the initial synchronization step when the new client terminal 200X switches modes to connect to the real-time network infrastructure 300, the communication controlling device 100A transmits the latest information of plurality of clients connected to the real-time network infrastructure 300 to the new client terminal 200X via the non-real-time network infrastructure 400.

In other words, in the initial synchronization step at the time of switching modes when the new client terminal 200X connects to the real-time network infrastructure 300, the communication controlling device 100A transmits the latest information of the plurality of clients connected to the real-time network infrastructure 300, via the non-real-time network infrastructure 400.

This effectively avoids an initial synchronization load and allows a pre-given network transfer capacity limit to be used without waste.

When the communication controlling device 100A of the network control system 1A according to the present embodiment receives information on the new client as the initial synchronization request from the new client terminal, transmits the latest information of the plurality of clients connected to the real-time network infrastructure to the new client terminal 200X, using the Nagle algorithm, via the non-real-time network infrastructure 400.

This effectively avoids the initial synchronization load and allows the pre-given network transfer capacity limit to be used without waste.

### Third Embodiment

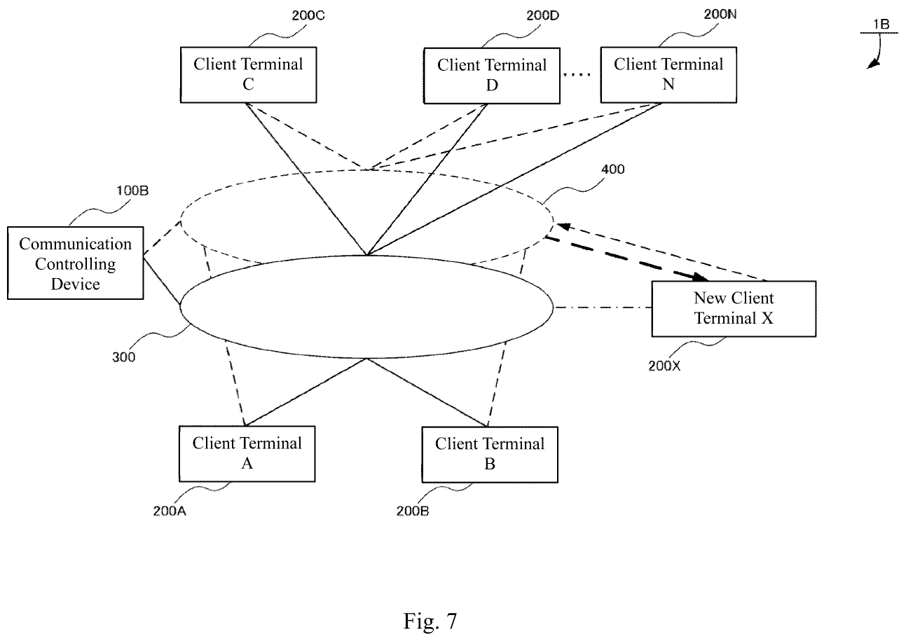

FIG. 7 to FIG. 9 are used to describe a network control system 1B according to a present embodiment.

### Network Control System 1B

As illustrated in FIG. 7, the network control system 1B according to the present embodiment comprises a communication controlling device 100B, client terminals 200A-200N, a new client terminal 200X, a real-time network infrastructure 300, and a non-real-time network infrastructure 400.

Detailed descriptions of components with the same symbols as in first and a second embodiments are omitted, since they have the same functions.

For example, when the communication controlling device 100B receives information on a new client as an initial synchronization request from the new client terminal 200X in an initial synchronization step at the time of switching modes when the new client terminal 200X connects to the real-time network infrastructure 300, if it is determined that a congestion state in the real-time network infrastructure 300 is above a standard congestion level, the communication controlling device 100B transmits latest information on plurality of clients connected to the real-time network infrastructure 300 via the non-real-time network infrastructure 400.

Details of configuration of the communication controlling device 100B are described below.

### Configuration of Communication Controlling Device 100B

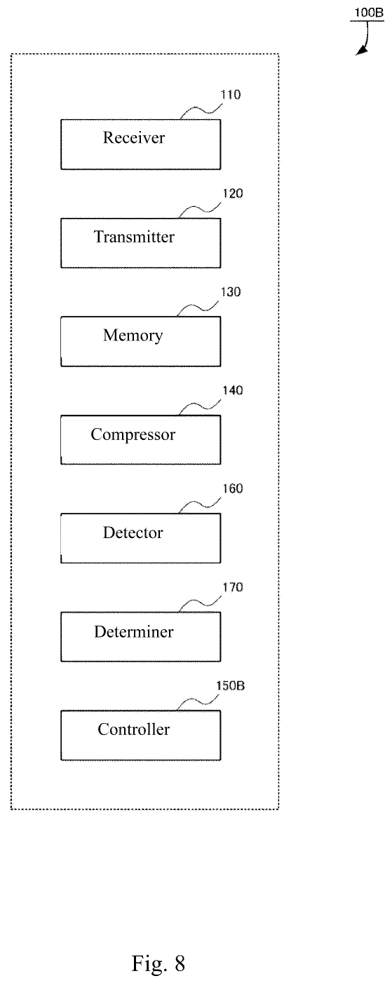

As illustrated in FIG. 8, the communication controlling device 100B comprises a receiver 110, a transmitter 120, a memory 130, a compressor 140, a controller 150B, a detector 160, and a determiner 170.

Detailed descriptions of components with the same symbols as those in first and second embodiments are omitted, as they have the same functions.

In the initial synchronization step at the time of switching modes when the new client terminal 200X connects to the real-time network infrastructure 300, when the detector 160 receive information on the new client as the initial synchronization request from the new client terminal 200X, the congestion state of the real-time network infrastructure 300 is detected.

A detection result in the detector 160 is output to the determiner 170 described below.

The determiner 170 determines whether the congestion state of the real-time network infrastructure 300 detected in the detector 160 is greater than or equal to the standard congestion level.

The standard congestion level may be freely determined.

The determined result in the determiner 170 is output to the controller 150B described below.

The controller 150B controls an operation of an entire network control system 1B according to a control program stored in ROM (Read Only Memory) or the like.

In the present embodiment, for example, when the receiver 110 receives information on the new client as the initial synchronization request from the new client terminal 200X in the initial synchronization step when the new client terminal 200X is connected to the real-time network infrastructure 300 during switching modes, if the detector 160 detects the congestion state in the real-time network infrastructure 300 and the determiner 170 determines that the congestion state in the real-time network infrastructure 300 is above the standard congestion level, the controller 150B requests the transmitter 120 to transmit, via the non-real-time network infrastructure 400, the latest information on the plurality of new clients connected to the real-time network infrastructure 300 to the new client terminal 200X.

For example, when the receiver 110 receives the information on the new client as the initial synchronization request from the new client terminal 200X, the controller 150B may control the transmitter 120 to transmit the latest information of the plurality of clients connected to the real-time network infrastructure to the new client terminal 200X, using the Nagle algorithm, via the non-real-time network infrastructure 400.

### Processing of Communication Controlling Device 100B

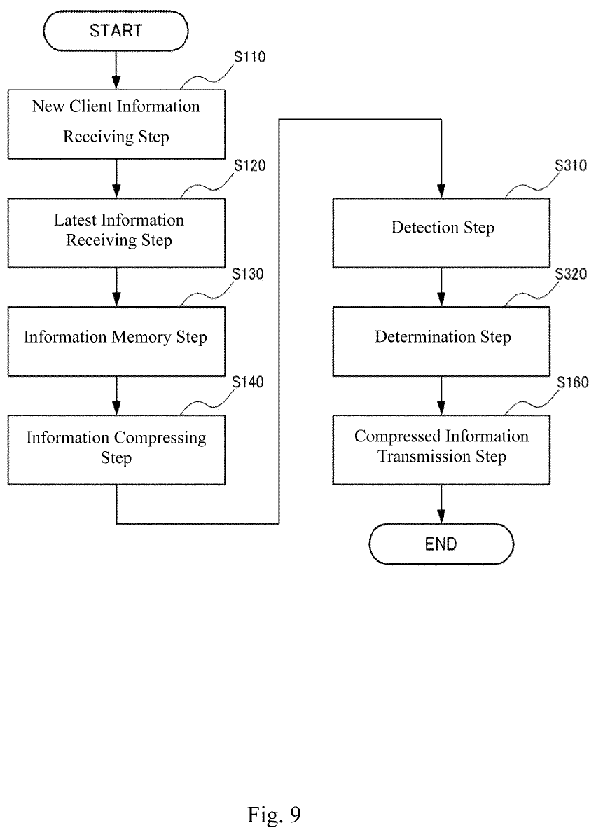

FIG. 9 is used to describe the processing of the network control system 1B according to the present embodiment.

The receiver 110 receives the information on the new client as the initial synchronization request from the new client terminal 200X (step S110).

The information on the new client (new client information) received by the receiver 110 is output to the controller 150B.

The receiver 110 receives the latest information of the plurality of clients from the client terminals 200A-200N connected to the real-time network infrastructure via the real-time network infrastructure 300 (step S120).

The latest information of the plurality of clients from the client terminals 200A-200N connected to the real-time network infrastructure received by the receiver 110 is output to the controller 150B.

By the process of the controller 150B writing the latest information of the plurality of clients from the client terminals 200A-200N connected to the real-time network infrastructure received from the receiver 110 to a storage area corresponding to the plurality of client terminals 200A-200N in the memory 130, the information in the storage area corresponding to the plurality of client terminals 200A-200N is updated (step S130).

When the information on the new client from the receiver 110 is received, the controller 150B reads the latest information on the plurality of clients in the storage area corresponding to the plurality of client terminals 200A-200N in the memory 130, and outputs the latest information to the compression section 140, as well as outputs a control signal to compress and process this information.

The compressor 140 compresses the latest information of the input group and outputs it to the controller 150B (step S140).

When the information of the new client as the initial synchronization request from the new client terminal 200X in the initial synchronization step at the time of switching modes when the new client terminal 200X connects to the real-time network infrastructure 300 is received, the detector 160 detects the congestion state of the real-time network infrastructure 300 (step S310).

The determiner 170 determines whether the congestion state of the real-time network infrastructure 300 detected in the detector 160 is above the standard congestion level (step S320).

When the congestion state in the real-time network infrastructure 300 is determined to be above the standard congestion level by the determiner 170, the controller 150B outputs the latest information of the group of compressed information received from the compressor 140 to the transmitter 120, and via the non-real-time network infrastructure 400, transmits the control signal ordering the transmission of the latest information of the plurality of clients connected to the real-time network infrastructure 300 to the new client terminal 200 (step S160).

At this time, the controller 150A may cause the transmitter 120 to transmit the information using the Nagle algorithm.

### Effect

As described above, the network control system 1A according to the present embodiment has the plurality of client terminals 200A-200N, the real-time network infrastructure 300 connecting the plurality of client terminals 200A-200N, the non-real-time network infrastructure 400 connecting the plurality of client terminals 200A-200N, the communication controlling device 100B that controls data communications in the real-time network infrastructure 300 and the non-real-time network infrastructure 400. When the receiver 110 receives information on the new client as the initial synchronization request from the new client terminal 200X in the initial synchronization step when the new client terminal 200X is connected to the real-time network infrastructure 300 during switching modes, if the detector 160 detects the congestion state in the real-time network infrastructure 300 and the determiner 170 determines that the congestion state in the real-time network infrastructure 300 is above the standard congestion level, the communication controlling device 100B requests the transmitter 120 to transmit, via the non-real-time network infrastructure 400, the latest information on the plurality of new clients connected to the real-time network infrastructure 300 to the new client terminal 200X.

This effectively avoids an initial synchronization load and allows a pre-given network transfer capacity limit to be used without waste.

When receiving information on the new client as the initial synchronization request from the new client terminal, the communication controlling device 100B of the network control system 1A according to the present embodiment transmits the latest information of the plurality of clients connecting to the real-time network infrastructure to the new client terminal 200X, via the non-real-time network infrastructure 400 using the Nagle algorithm.

This effectively avoids the initial synchronization load and allows the pre-given network transfer capacity limit to be used without waste.

### Variation

The network control systems 1, 1A, 1B in the first to third embodiments were so-called stand-alone systems.

As an advanced form of this, a plurality of the above systems may be interconnected via communication controlling devices 100, 100A, and 100B to form a so-called “cluster” system.

A cluster system is expected to increase a number of accesses and improve a performance of the system.

The network control systems 1, 1A, 1B of the present invention can be realized by recording processing of the communication controlling devices 100, 100A, 100B on a recording medium readable by a computer system and having the communication controlling devices 100, 100A, 100B read and execute a program recorded on this recording medium. The computer system here includes an OS and a hardware such as peripheral devices.

The “computer system” shall also include a homepage provision environment (or display environment) if the WWW (World Wide Web) system is used. The above program may be transmitted from the computer system that stores this program in the storage device and such, to another computer system via a transmission medium or by transmission waves in the transmission medium. Here, the “transmission medium” for transmitting the program refers to a medium that has functions of transmitting information, such as a network (communication network) such as the Internet or a communication line such as a telephone line.

The above program may also be the program to realize some of the aforementioned functions. Furthermore, it may be a so-called difference file (difference program), which can realize the aforementioned functions in combination with the program already recorded in the computer system.

The above embodiments of this invention have been described in detail with reference to the drawings. Specific configurations are not limited to these embodiments, but also include designs and such, to the extent that they do not depart from the gist of this invention.

### EXPLANATION OF THE REFERENCE NUMERALS

1: Network Control System
1A: Network Control System
1B: Network Control System
100: Communication Controlling Device
100A: Communication Controlling Device
100B: Communication Controlling Device
110: Receiver
120: Transmitter
130: Memory
140: Compressor
150: Controller
150A: Controller
150B: Controller
200A-N: Client Terminals
200X: New Client Terminal
300: Real-time Network Infrastructure
400: Non-real-time Network Infrastructure

1. A network control system comprising:
a plurality of client terminals;
a real-time network infrastructure connecting the plurality of client terminals;
a non-real-time network infrastructure connecting the plurality of client terminals; and
a communication controlling device that controls data communications in the real-time network infrastructure and the non-real-time network infrastructure,
wherein, in an initial synchronization step at a time of switching modes when a new client terminal connects to the real-time network infrastructure, if the communication controlling device receives information on a new client as an initial synchronization request from the new client terminal, the communication controlling device transmits latest information on plurality of clients connected to the real-time network infrastructure to the new client terminal via the non-real-time network infrastructure.

2. The network control system according to claim 1,
wherein the communication controlling device comprises:
a detector that detects a congestion state of the real-time network infrastructure when information on the new client is received from the new client terminal as the initial synchronization request during the initial synchronization step at the time of switching modes when the new client terminal connects to the real-time network infrastructure; and
a determiner that determines whether the congestion state is above a standard congestion level,
wherein the communication controlling device transmits the latest information of the plurality of clients connected to the real-time network infrastructure to the new client terminal via the non-real-time network infrastructure if the congestion state is determined by the determiner to be above the standard congestion level.

3. The network control system according to claim 1,
wherein the communication controlling device comprises a memory that stores the latest information on the plurality of clients connected to the real-time network infrastructure.

4. The network control system according to claim 3,
wherein the communication controlling device comprises a compressor that compresses the latest information on the plurality of clients connected to the real-time network infrastructure stored in the memory.

5. The network control system according to claim 4,
wherein, when the communication controlling device receives information on the new client as the initial synchronization request from the new client terminal, the communication controlling device uses a Nagle algorithm to transmit the latest information on the plurality of clients connected to the real-time network infrastructure to the new client terminal via the non-real-time network infrastructure.

6. A non-transitory computer-readable storage medium storing a program for having a computer execute a network control method in a network control system comprising:
a plurality of client terminals;
a real-time network infrastructure connecting the plurality of client terminals;
a non-real-time network infrastructure connecting the plurality of client terminals; and
a communication controlling device controlling data communication in the real-time network infrastructure and the non-real-time network infrastructure, and comprising the steps of:
a client information receiving step in which the communication controlling device receives information on a new client as an initial synchronization request from a new client terminal in an initial synchronization step during switching modes where the new client terminal connects to the real-time network infrastructure; and
an information transmission step in which the communication controlling device transmits latest information on the plurality of clients connected to the real-time network infrastructure to the new client terminal via the non-real-time network infrastructure.

7. The non-transitory computer-readable storage medium storing the program according to claim 6, the program comprising:
a congestion state detection step in which the communication controlling device detects a congestion state of the real-time network infrastructure; and
a determination step in which the communication controlling device determines whether the congestion state is above a standard congestion level,
wherein, when it is determined in the determination step that the congestion state is above the standard congestion level, the communication controlling device transmits the latest information on the plurality of clients connected to the real-time network infrastructure via the non-real-time network infrastructure to the new client terminal, in the information transmission step.

8. The non-transitory computer-readable storage medium storing the program according to claim 6,
wherein the communication controlling device comprises an information storage step for storing the latest information on the plurality of clients connected to the real-time network infrastructure prior to the information transmission step.

9. The non-transitory computer-readable storage medium storing the program according to claim 8,
wherein the communication controlling device comprises an information compression step to compress stored latest information on the plurality of clients connecting to the real-time network infrastructure.

10. The non-transitory computer-readable storage medium storing the program according to claim 9,
wherein the communication controlling device uses a Nagle algorithm in the information transmission step to transmit the latest information on the plurality of clients connected to the real-time network infrastructure to the new client terminal via the non-real-time network infrastructure.
